(19) United States
(12) Patent Application Publication
(10) Pub. No.: US 2025/0140861 A1
(43) Pub. Date: May 1, 2025

(54) ELECTRODE BINDER, ELECTRODE MIXTURE LAYER-FORMING COMPOSITION, LITHIUM ION SECONDARY BATTERY ELECTRODE, AND LITHIUM ION SECONDARY BATTERY

(71) Applicants: TOAGOSEI CO., LTD., Tokyo (JP); National University Corporation Tokyo University of Agriculture and Technology, Tokyo (JP)

(72) Inventors: Tomoko Nakano, Aichi (JP); Naohiko Saito, Aichi (JP); Yoichi Tominaga, Tokyo (JP)

(73) Assignees: TOAGOSEI CO., LTD., Tokyo (JP); National University Corporation Tokyo University of Agriculture and Technology, Tokyo (JP)

(21) Appl. No.: 18/681,700

(22) PCT Filed: Aug. 1, 2022
(86) PCT No.: PCT/JP2022/029517

§ 371 Date: Feb. 6, 2024

(30) Foreign Application Priority Data
Aug. 6, 2021 (JP) 2021-130251

(51) Int. Cl. H01M 4/62; C08F 220/06; H01M 4/131; H01M 4/58; H01M 10/0525

(52) U.S. Cl. CPC H01M 4/622; C08F 220/06; H01M 4/131; H01M 4/5825; H01M 10/0525; C08F 2810/20; C08F 2810/50

(57) ABSTRACT

In an electrode binder of a lithium ion secondary battery including a polymer solid electrolyte, the binder employs a polymer (A) which is a carboxyl group-containing polymer or a salt thereof and which provides a 5 mass % aqueous solution of the polymer (A) has a viscosity of 10,000 mPa·s or more at 25° C.

### CROSS-REFERENCE TO RELATED APPLICATIONS

The present application claims the benefit of Japanese Patent Application No. 2021-130251 filed on Aug. 6, 2021, the disclosure of which is incorporated herein by reference.

### TECHNICAL FIELD

The present disclosure relates to an electrode binder; to an electrode mixture layer-forming composition; to a lithium ion secondary battery electrode; and to a lithium ion secondary battery.

### BACKGROUND ART

A variety of electrical power storage devices, including a nickel-hydrogen secondary battery, a lithium ion secondary battery, and an electric double layer capacitor, have been practically used as secondary batteries. Among such secondary batteries, a lithium ion secondary battery finds a wide range of uses by virtue of high energy density and high battery capacity.

A lithium ion secondary battery is a type of secondary battery which includes a negative electrode, a positive electrode, and an electrolyte, and in which lithium ions are caused to move between the electrodes by the mediation of the electrolyte, to thereby achieve charging and discharging.

Conventionally, an organic electrolytic solution is mainly used as an electrolyte. In recent years, however, use of a solid electrolyte instead of an organic electrolytic solution has been proposed as an alternative technique for eliminating the risk of leakage of electrolytic solution and short circuit in the battery, which would be evoked by over-charging or over-discharging. Among such solid electrolytes, a polymer solid electrolyte is advantageous, in that the electrolyte has a flexibility higher than that of an inorganic solid electrolyte, to thereby achieve production of a flexible all-solid lithium ion secondary battery, and that the internal resistance of the battery attributed to the interface between the active material and the electrolyte is small.

Generally, an electrode of a lithium ion secondary battery is equipped with a current collector formed of metal foil, and an electrode mixture layer is disposed on the surface of the current collector. The electrode mixture layer is formed by fixing the active material with binder for forming the electrode (see, for example, Patent Document 1). Patent Document 1 discloses a lithium ion secondary battery which includes an electrode formed from a slurry prepared by employing poly(vinylidene fluoride) (PVDF) as an electrode binder and dispersing the active material and PVDF in N-methyl-2-pyrrolidone (NMP); and a gel-type polymer solid electrolyte.

### PRIOR ART DOCUMENT

### Patent Document

Patent Document 1: Japanese Patent Application Laid-Open (kokai) No. 2002-33017

### SUMMARY OF INVENTION

### Technical Problem

According to previous studies conducted by the present inventors, PVDF was used as an electrode binder for producing an electrode of a lithium ion secondary battery containing a polymer solid electrolyte, and an NMP solution of PVDF and the active material was employed so as to produce an electrode of a lithium ion secondary battery. In the thus-produced electrode, surface roughness was observed on the electrode, and the internal resistance of the electrode was greater. In addition, it was confirmed that the initial battery capacity was not satisfactory, and battery capacity dropped even in a step which has passed only a small number of charge/discharge cycles. From the viewpoint of practical use, a lithium ion secondary battery is required to exhibit a small drop in battery capacity even after repeated charge/discharge processes and excellent cycle characteristics. Also, from the viewpoint of reducing an environmental load, it is desired that the aforementioned improvement in battery characteristics be realized by use of an aqueous electrode binder.

The present disclosure has been realized under the aforementioned circumstances. Thus, a main object of the present disclosure is to provide an aqueous binder for producing an electrode, which binder can produce an electrode having excellent surface flatness and small internal resistance and which can provide a lithium ion secondary battery exhibiting a high initial battery capacity and excellent cycle characteristics.

### Solution to Problem

The present disclosure provides the following means.

[1] An electrode binder of a lithium ion secondary battery including a polymer solid electrolyte, wherein the binder contains a polymer (A) which is a carboxyl group-containing polymer or a salt thereof, and a 5% by mass (hereinafter may be referred to as “5 mass %”) aqueous solution of the polymer (A) has a viscosity of 10,000 mPa·s or more at 25° C.

[2] The electrode binder of [1] above, wherein the polymer (A) has a neutralization degree of 70 mol % or higher.

[3] The electrode binder of [1] or [2] above, wherein the polymer (A) includes a structural unit derived from a cross-linkable monomer, and the relative amount of the structural unit derived from the cross-linkable monomer in the polymer (A) with respect to the entire amount of a structural unit derived from a monomer other than the cross-linkable monomer is 0.001 mol % to 2.5 mol %.

[4] The electrode binder of any of [1] to [3] above, wherein the polymer (A) includes a structural unit derived from an ethylenically unsaturated monomer having a carboxyl group, and the relative amount of the structural unit derived from the ethylenically unsaturated monomer having a carboxyl group in the polymer (A) with respect to all the structural units of the polymer (A) is 50 mass % or more.

[5] The electrode binder of any of [1] to [4] above, wherein the polymer solid electrolyte contains an alkylene carbonate group-containing polymer.

[6] The electrode binder according of [5] above, wherein the alkylene carbonate group-containing polymer is polyethylene carbonate.

[7] The electrode binder of any of [1] to [6] above, wherein the polymer (A) is a lithium salt of the carboxyl group-containing polymer.

[8] The electrode binder of any of [1] to [7] above, which is a positive electrode binder.

[9] An electrode mixture layer-forming composition of a lithium ion secondary battery including a polymer solid electrolyte, wherein the composition comprises the electrode binder of any of [1] to [8] above and an active material.

[10] The electrode mixture layer-forming composition of [9] above, wherein the active material is iron lithium phosphate.

[11] The electrode mixture layer-forming composition of [9] or [10] above, which further contains a conducting aid.

[12]A lithium ion secondary battery electrode, the electrode including a current collector, and an electrode mixture layer disposed on a surface of the current collector, wherein the electrode mixture layer is formed from the electrode mixture layer-forming composition of any of [9] to [11].

[13]A lithium ion secondary battery including a lithium ion secondary battery electrode of [12] above.

### Advantageous Effects of Invention

According to the present disclosure, an electrode binder containing a polymer (A) which is a carboxyl group-containing polymer or a salt thereof and which provides a 5 mass % aqueous solution thereof having a viscosity of 10,000 mPa·s or more at 25° C. is used, whereby an electrode having excellent surface flatness and small internal resistance can be produced. In addition, a lithium ion secondary battery that can provide a high initial battery capacity and suitable cycle characteristics can be produced. Furthermore, since the polymer (A) can be dissolved or dispersed in water, the amount of organic solvent used can be reduced, thereby reducing an environmental load.

### DESCRIPTION OF EMBODIMENTS

The present disclosure will next be described in detail. In the present specification, the expression “(meth)acrylic” refers to “acrylic or methacrylic or both.” Similarly, “(meth)acrylate” refers to “acrylate or methacrylate or both.”

<<Electrode binder>>

The electrode binder of the present disclosure is employed for producing an electrode of a lithium ion secondary battery containing a polymer solid electrolyte (more specifically, for producing an electrode mixture layer). The binder binds the active material molecules contained in the electrode mixture layer. The electrode binder of the present disclosure includes a polymer (A) which is a carboxyl group-containing polymer or a salt thereof and which provides a 5 mass % aqueous solution thereof having a viscosity of 10,000 mPa·s or more at 25° C.

### <Polymer (A)>

No particular limitation is imposed on the polymer (A), so long as the polymer (A) has a group represented by “—COOH” and/or “[—COO—]ₙRⁿ⁺” (wherein Rⁿ⁺ represents a counter ion to the carboxyl group; and n is an integer of 1 or greater (preferably 1 or 2)). Examples of the polymer (A) include a polymer having a plurality of “—COOH” and/or “[—COO—]ₙRⁿ⁺”. A polymer mainly including a structural unit derived from an ethylenically unsaturated monomer having a carboxyl group (hereinafter may also be referred to as a “carboxylic monomer”) is preferably used as the polymer (A). Specific examples of the carboxylic monomer include (meth)acrylic acid, itaconic acid, crotonic acid, maleic acid, fumaric acid, citraconic acid, cinnamic acid, monohydroxyethyl (meth)acrylate succinate, ω-carboxy-caprolactone mono(meth)acrylate, β-carboxyethyl (meth)acrylate, and 4-carboxystyrene.

Among the above carboxylic monomers, (meth)acrylic acid is preferred. When the polymer (A) includes a structural unit derived from (meth)acrylic acid, in the case where an alkylene carbonate group-containing polymer is used as a polymer component of the polymer solid electrolyte of a lithium ion secondary battery, close adhesion between the electrode and the polymer solid electrolyte can be enhanced. As a result, cycle characteristics can be suitably improved.

In the case where the polymer (A) is a salt of a carboxyl group-containing polymer, examples of the counter ion to the carboxyl group (Rⁿ⁺) include lithium ion, sodium ion, potassium ion, magnesium ion, and calcium ion. Of these, lithium ion, sodium ion, and potassium ion are preferred, with lithium ion being more preferred. A polymer (A) which is a lithium salt of a carboxyl group-containing polymer can be suitably lower the electrical resistance of the electrode.

In the polymer (A), the relative amount of the structural unit derived from the carboxylic monomer with respect to all the structural units forming the polymer (A) is preferably 50 mass % or more, more preferably 60 mass % or more, still more preferably 70 mass % or more, yet more preferably 80 mass % or more, further more preferably 90 mass % or more. When the relative amount of the structural unit derived from the carboxylic monomer in the polymer (A) satisfied the above conditions, in the case where the polymer solid electrolyte contains an alkylene carbonate group-containing polymer, close adhesion between the electrode and the polymer solid electrolyte can be enhanced, which is preferred. The carboxylic monomers forming the polymer (A) may be used singly or in combination of two or more species.

The method of producing the polymer (A) is not limited to a method employing a carboxylic monomer. In one alternative production method, a (meth)acrylate ester monomer is polymerized, and the formed polymer is hydrolyzed, to thereby yield the polymer (A). In a yet alternative production method, a nitrogen-containing monomer such as (meth)acrylamide or (meth)acrylonitrile is polymerized, and the formed polymer is treated with a strong alkali, to thereby yield the polymer (A). In a still alternative production method, a polymer having a hydroxyl group is reacted with an acid anhydride, to thereby yield the polymer (A).

The viscosity of the 5 mass % aqueous solution of the polymer (A) at 25° C. is 10,000 mPa·s or more. By use of a high-viscosity carboxyl group-containing polymer having a viscosity falling within the above range as an electrode binder, dispersibility of the active material increases, whereby the surface flatness of the electrode can be enhanced. As the polymer (A) which provides a 5 mass % aqueous solution having a viscosity of 10,000 mPa·s or more at 25° C., a cross-linked polymer or a polymer having a weight average molecular weight of 500,000 or higher (hereinafter may also be referred to as a “high-molecular weight polymer”) is preferably used. Among them, a cross-linked polymer is preferably used as the polymer (A), since a drop in battery capacity involved in repeated charge/discharge processes of a lithium ion secondary battery can be suppressed to thereby yield a lithium ion secondary battery exhibiting more favorable cycle characteristics, and the surface flatness of the electrode can be considerably enhanced.

From the viewpoint of enhancing the surface flatness of the electrode, the viscosity of the 5 mass % aqueous solution of the polymer (A) at 25° C. is preferably 15,000 mPa·s or more, more preferably 18,000 mPa·s or more, still more preferably 20,000 mPa·s or more, yet more preferably 25,000 mPa·s or more, further more preferably 30,000 mPa·s or more. The viscosity of an aqueous solution containing the polymer (A) is measured by means of a type-B viscometer at 25° C. and a rotor speed of 12 rpm. The measurement method is in accordance with the method described in the below-mentioned Examples.

No particular limitation is imposed on the upper limit of the viscosity of the 5 mass % aqueous solution of the polymer (A) at 25° C. From the viewpoint of handling performance of the polymer (A), the viscosity measured by means of a type-E viscometer at 25° C. and a rotor speed of 0.6 rpm is, for example, 1,000,000 mPa·s or less, preferably 900,000 mPa·s or less, more preferably 800,000 mPa·s or less, still more preferably 700,000 mPa·s or less.

No particular limitation is imposed on the method of producing the cross-linked polymer. Examples of the cross-linked polymer production method include the following methods (1) and (2):
(1) copolymerization of a monomer having a cross-linkable functional group (hereinafter may also be referred to as a “cross-linkable monomer”) and a monomer which differs from the cross-linkable monomer and which can be copolymerized with the cross-linkable monomer (hereinafter may also be referred to as a “non-cross-linkable monomer”); and
(2) synthesis of a polymer having a reactive functional group and optional cross-linking by adding a cross-linking agent.

Of these, method (1) is preferred, since the operation is simple, and the degree of cross-linking can be easily controlled.

As the cross-linkable monomer, an ethylenically unsaturated monomer having a cross-linkable functional group is preferably used. Specific examples of the cross-linkable monomer include a multi-functional polymerizable monomer having two or more ethylenically unsaturated groups, and a self-cross-linkable monomer having a self-cross-linkable functional group (e.g., a hydrolyzable silyl group). Specific examples of the multi-functional polymerizable monomer include a multi-functional (meth)acrylate compound, a multi-functional alkenyl compound, and a compound having both a (meth)acryloyl group and an alkenyl group. Among them, the ethylenically unsaturated monomer having a cross-linkable functional group is preferably a compound having an alkenyl group (a multi-functional alkenyl group or a compound having both a (meth)acryloyl group and an alkenyl group), with a multi-functional alkenyl compound being more preferred, from the viewpoint of easily forming a uniform cross-link structure.

Specific examples of the multi-functional alkenyl compound include multi-functional allyl ether compounds such as trimethylolpropane diallyl ether, trimethylolpropane triallyl ether, pentaerythritol diallyl ether, pentaerythritol triallyl ether, tetraallyloxyethane, and polyallysaccharose; multi-functional allyl compounds such as diallyl phthalate; and multi-functional vinyl compounds such as divinylbenzene. Examples of the (meth)acrylic acid compound having both a (meth)acryloyl group and an alkenyl group include alkenyl group-containing (meth)acrylic acid compounds such as allyl (meth)acrylate, isopropenyl (meth)acrylate, butenyl (meth)acrylate, pentenyl (meth)acrylate, and 2-(2-vinyloxyethoxy)ethyl (meth)acrylate. Of these, a multi-functional allyl ether compound having a plurality of allyl ether groups in the molecule thereof is particularly preferred as the multi-functional alkenyl compound.

Specific examples of the self-cross-linkable monomer include a vinyl monomer having a hydrolyzable silyl group. Examples of the vinyl monomer having a hydrolyzable silyl group include vinyl silanes such as vinyltrimethoxysilane, vinyltriethoxysilane, vinylmethyldimethoxysilane, and vinyldimethylmethoxysilane; silyl group-containing (meth)acrylate esters such as trimethoxysilylpropyl (meth)acrylate, triethoxysilylpropyl (meth)acrylate, and methyldimethoxysilylpropyl (meth)acrylate; trimethoxysilylpropyl vinyl ether; and vinyl trimethoxysilylundecanate.

When the polymer (A) includes a structural unit derived from a cross-linkable monomer, the relative amount of the structural unit derived from a cross-linkable monomer in the polymer (A) with respect to the entire amount (100 parts by mass) of a structural unit derived from a monomer other than the cross-linkable monomer (i.e., a non-cross-linkable monomer) is preferably 0.05 parts by mass to 5.0 parts by mass. When the relative amount of the structural unit derived from a cross-linkable monomer is 0.05 parts by mass or more, a satisfactory effect of improving dispersibility of the active material in the electrode can be achieved. When the relative amount is 5.0 parts by mass or less, a lithium ion secondary battery having more suitable cycle characteristics can be produced.

From the above viewpoints, the relative amount of the structural unit derived from a cross-linkable monomer in the polymer (A) with respect to the entire amount (100 parts by mass) of a structural unit derived from a non-cross-linkable monomer is preferably 0.1 parts by mass or more, more preferably 0.2 parts by mass or more, still more preferably 0.3 parts by mass or more. Regarding the upper limit of the relative amount of the structural unit derived from a cross-linkable monomer, the relative amount with respect to the entire amount (100 parts by mass) of a structural unit derived from a non-cross-linkable monomer is preferably 4.0 parts by mass or less, more preferably 3.5 parts by mass or less, still more preferably 3.0 parts by mass or less, yet more preferably 2.5 parts by mass or less, further more preferably 2.0 parts by mass or less, yet further more preferably 1.5 parts by mass or less. The cross-linkable monomers forming the polymer (A) may be used singly or in combination of two or more species. The non-cross-linkable monomer includes a carboxylic monomer.

Similarly, in the polymer (A), the relative amount of the structural unit derived from a cross-linkable monomer with respect to the entire amount of a structural unit derived from a non-cross-linkable monomer is preferably 0.001 mol % to 2.5 mol %. The relative amount of the structural unit derived from a cross-linkable monomer with respect to the entire amount of a structural unit derived from a non-cross-linkable monomer is more preferably 0.01 mol % or more, still more preferably 0.03 mol % or more, yet more preferably 0.05 mol % or more, further more preferably 0.10 mol % or more. Regarding the upper limit of the relative amount of the structural unit derived from a cross-linkable monomer, the relative amount with respect to the entire amount of a structural unit derived from a non-cross-linkable monomer is more preferably 2.0 mol % or less, still more preferably 1.5 mol % or less, yet more preferably 1.0 mol % or less, further more preferably 0.50 mol % or less.

So long as the effects of the present disclosure are not impaired, the polymer (A) may further include a structural unit derived from a monomer differing from a carboxylic monomer and a cross-linkable monomer (hereinafter may be referred to as an “additional monomer”). An ethylenically unsaturated monomer is preferably used as the additional monomer. Examples of the additional monomer include alkyl (meth)acrylate ester, alicyclic (meth)acrylate ester, aromatic (meth)acrylate ester, alkoxyalkyl (meth)acrylate ester, hydroxyalkyl (meth)acrylate ester, and polyalkylene glycol mono(meth)acrylate.

Specific examples of the alkyl (meth)acrylate ester include methyl (meth)acrylate, ethyl (meth)acrylate, isopropyl (meth)acrylate, n-propyl (meth)acrylate, n-butyl (meth)acrylate, isobutyl (meth)acrylate, tert-butyl (meth)acrylate, hexyl (meth)acrylate, and 2-ethylhexyl (meth)acrylate.

Specific examples of the alicyclic (meth)acrylate ester include cyclohexyl (meth)acrylate, methylcyclohexyl (meth)acrylate, tert-butylcyclohexyl (meth)acrylate, cyclododecyl (meth)acrylate, isobornyl (meth)acrylate, adamantyl (meth)acrylate, dicyclopentenyl (meth)acrylate, and dicyclopentanyl (meth)acrylate. Specific examples of the aromatic (meth)acrylate ester include phenyl (meth)acrylate, benzyl (meth)acrylate, phenoxymethyl (meth)acrylate, 2-pnenoxyethyl (meth)acrylate, and 3-phenoxypropyl (meth)acrylate.

Specific examples of the alkoxyalkyl (meth)acrylate ester include methoxyethyl (meth)acrylate, ethoxyethyl (meth)acrylate, n-propoxyethyl (meth)acrylate, n-butoxyethyl (meth)acrylate, methoxypropyl (meth)acrylate, ethoxypropyl (meth)acrylate, n-propoxypropyl (meth)acrylate, n-butoxypropyl (meth)acrylate, methoxybutyl (meth)acrylate, ethoxybutyl (meth)acrylate, n-propoxybutyl (meth)acrylate, and n-butoxybutyl (meth)acrylate.

Specific examples of the hydroxyalkyl (meth)acrylate ester include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Examples of the polyalkylene glycol mono(meth)acrylate include polyethylene glycol mono(meth)acrylate, polypropylene glycol mono(meth)acrylate, and polyethylene glycol-polypropylene glycol mono(meth)acrylate.

When the polymer (A) includes a structural unit derived from an additional monomer, the relative amount of the structural unit derived from an additional monomer with respect to all the structural units forming the polymer (A) is preferably 60 mass % or less, more preferably 50 mass % or less, still more preferably 40 mass % or less. The additional monomers forming the polymer (A) may be used singly or in combination of two or more species.

When a cross-linked polymer is used as the polymer (A), a commercial product thereof may be used. Examples of the commercial product include products (as tradenames) such as JUNLON (registered trademark) PW-120, JUNLON PW-121, and JUNLON PW-312S (products of TOAGOSEI Co., Ltd.); and Carbopol 934P NF, Carbopol 981, Carbopol Ultrez10, and Carbopol Ultrez30 (products of Lubrizol).

When a high-molecular weight polymer is used as the polymer (A), the weight average molecular weight (Mw) of the polymer is preferably 500,000 or higher, more preferably 800,000 or higher, still more preferably 1,000,000 or higher, yet more preferably 1,500,000 or higher, from the viewpoints of enhancement in dispersibility of the active material in the electrode mixture layer and surface flatness of the electrode. Also, from the viewpoint of handling performance, the weight average molecular weight (Mw) of the high-molecular weight polymer is preferably 50,000,000 or lower, more preferably 30,000,000 or lower, still more preferably 10,000,000 or lower. Meanwhile, the molecular weight of the high-molecular weight polymer is a value obtained by methylating a carboxyl group with trimethylsilyldiazomethane, measuring through gel permeation chromatography (GPC) with tetrahydrofuran as an eluent, and reducing the measurement to polystyrene.

The polymer (A) may be any of a carboxyl group-containing polymer or its salt. Among them, from the viewpoints of improving the cycle characteristics of a lithium ion secondary battery and reducing the internal resistance of the electrode, the polymer (A) is preferably a salt of a carboxyl group-containing polymer; that is, a mode of a salt provided by neutralizing at least a part of the acid moiety of the carboxyl group-containing polymer.

In the case where the polymer (A) is a salt of the carboxyl group-containing polymer, the neutralization degree of the polymer (A) is preferably 70 mol % or more, more preferably 75 mol % or more, still more preferably 80 mol % or more, yet more preferably 85 mol % or more, further more preferably 90 mol % or more, from the viewpoints of improving the cycle characteristics of a lithium ion secondary battery and reducing the internal resistance of the electrode. The neutralization degree of the polymer (A) is a value calculated from the ratio of a peak intensity attributed to a C═O bond of carboxylic acid salt to a peak intensity attributed to a C═O bond of carboxylic acid, the peak intensity values being obtained through infrared spectroscopy (IR). The details of the measurement are given in the below-described Examples.

Particularly when the polymer (A) has a sufficiently high neutralization degree and a relative amount of structural unit derived from a cross-linkable monomer which is sufficiently smaller than the entire amount of a structural unit derived from a non-cross-linkable monomer in the polymer (A), the effect of improving cycle characteristics of a lithium ion secondary battery can be enhanced, which is preferred. In this case, the preferred ranges of neutralization degree of the polymer (A) and the amount of the structural unit derived from a cross-linkable monomer are the same as those described above.

### <Method for Producing Polymer (A)>

No particular limitation is imposed on the polymerization method for producing the polymer (A). Actually, the polymer (A) may be produced by polymerizing monomers through, for example, a known polymerization technique such as solution polymerization, precipitation polymerization, suspension polymerization, or emulsion polymerization. Among these techniques, precipitation polymerization or suspension polymerization, (reverse-phase suspension polymerization) is preferably employed, from the viewpoint of productivity. Also, from the viewpoint of further enhancing a property such as binding performance, an inhomogeneous-system polymerization technique such as precipitation polymerization, suspension polymerization, or emulsion polymerization is preferred. In particular, precipitation polymerization is preferred.

Precipitation polymerization is a method for producing a polymer, in which polymerization reaction is carried out in a solvent that can dissolve an unsaturated monomer but cannot substantially dissolve the formed polymer. In precipitation polymerization, the size of polymer particles increases with the progress of polymerization via aggregation and growth of the particles. As a result, primary particles having a size of some tens of nanometers to some hundreds of nanometers aggregate to form secondary particles having a size of some micrometers to some tens of micrometers, and a polymer particle dispersion containing such particles is obtained. In order to suppress excessive aggregation of polymer particles for stabilization, a dispersion stabilizer is preferably used. A mode of precipitation polymerization in which secondary aggregation of polymer particles is suppressed by adding a dispersion stabilizer or another means is also called “dispersion polymerization.”

In precipitation polymerization, a solvent selected from water, various organic solvents, and other solvents may be used as the solvent used for polymerization, in consideration of the type and other properties of the monomers employed. From the viewpoint of forming a polymer having a long primary chain length, a solvent having a small chain transfer constant is preferably used.

Specific examples of the solvent for polymerization include aqueous solvents such as methanol, t-butyl alcohol, acetone, methyl ethyl ketone, acetonitrile, and tetrahydrofuran; and other solvents such as benzene, ethyl acetate, dichloroethane, n-hexane, cyclohexane, and n-heptane. These solvents for polymerization may be used singly or in combination of two or more species. Among these specific solvents, the solvent for polymerization preferably includes ethyl ketone or acetonitrile or both, from the viewpoints of suppression of coarse particle formation and deposition to a reactor, favorable polymerization stability, prevention of secondary aggregation of deposited polymer microparticles, production of a polymer having a great polymerization degree (primary chain length) and a small chain transfer constant, and easy operation in the below-mentioned in-process neutralization.

In order to proceed neutralization reaction at high stability and speed in the in-process neutralization, the solvent for polymerization preferably contains a small amount of a high-polarity solvent. As the high-polarity solvent, water and methanol are preferably used. The amount of the high-polarity solvent used is preferably 0.05 to 20 mass % with respect to the total mass of the solvent, more preferably 0.1 to 10 mass %.

When polymerization is performed through precipitation polymerization, the monomer concentration at the start of polymerization is generally about 2 to about 40 mass %, preferably 5 to 40 mass %, from the viewpoint of producing a polymer having a longer primary chain length. Generally, as the monomer concentration at polymerization increases, the molecular weight of the formed polymer increases. That is, a polymer having a long primary chain length can be yielded.

As the dispersion stabilizer, a basic compound is preferably used. The basic compound may be any of an inorganic basic compound and an organic basic compound. Specific examples of the inorganic basic compound include alkali metal hydroxides such as lithium hydroxide, sodium hydroxide, and potassium hydroxide; and alkaline earth metal hydroxides such as calcium hydroxide and magnesium hydroxide. Specific examples of the organic basic compound include organic amine compounds such as monoethylamine, diethylamine, triethylamine, and tri-n-octylamine; and ammonia. Among them, organic amine compounds are preferred, from the viewpoints of polymerization stability and binding performance of an electrode binder.

The amount of the basic compound to be used may be appropriately set and is preferably 0.001 to 4.0 mol % with respect to the entire amount of the carboxylic monomer(s) involved in polymerization. The amount of the basic compound to be used is more preferably 0.05 to 4.0 mol % with respect to the entire amount of the carboxylic monomer(s) involved in polymerization, still more preferably 0.1 to 3.0 mol %. The amount of the basic compound to be used is the amount of the used basic compound with respect to the carboxylic monomer(s) in terms of mole concentration, and does not mean the neutralization degree. That is, the valence of the basic compound is not taken into account.

As the polymerization initiator, a known polymerization initiator such as an azo-type compound, an organic peroxide, or an inorganic peroxide may be used. Specific examples of the azo-type compound include 2,2′-azobis(2,4-dimethylvaleronitrile), 2,2′-azobis(N-butyl-2-methylpropionamide), 2-(tert-butylazo)-2-cyanopropane, 2,2′-azobis(2,4,4-trimethylpentane), and 2,2′-azobis(2-methylpropane). The amount of the polymerization initiator to be used is generally 0.001 to 2 parts by mass with respect to the entire amount of the monomer(s) involved in polymerization as 100 parts by mass. From the viewpoints of consistently performing polymerization reaction and forming a polymer having a long primary chain length, the amount of the polymerization initiator is preferably 0.005 to 1 part by mass.

Polymerization temperature, which varies depending on the type, concentration, etc. of the monomer(s) used, is preferably 0 to 100° C., more preferably 20 to 80° C. The polymerization temperature may be constant or may vary in the course of polymerization reaction. Polymerization time is preferably 1 minute to 20 hours, more preferably 1 hour to 10 hours.

When the polymer dispersion obtained through the above polymerization reaction is subjected to a drying process (e.g., reduced pressure treatment and/or heating treatment) and the solvent of the dispersion is distilled out, a target polymer can be yielded in the form of powder. For the purpose of removing unreacted monomer(s) (and a salt thereof), impurity matter originating from the initiator, and the like, before carrying out the drying process, a solid-liquid separation treatment (e.g., centrifugation or filtration) and a washing treatment with solvent are preferably conducted after the polymerization reaction. Examples of the solvent used in the washing treatment include water, methanol, and the same solvents employed as the solvent for polymerization.

In the case where a salt of the carboxyl group-containing polymer is used as the polymer (A), there may be employed a procedure which includes adding an alkaline compound to the polymer dispersion obtained through the above polymerization, to thereby neutralize the polymer (hereinafter may also be referred to as an “in-process neutralization”) and then carrying out the drying process so as to remove the solvent. In an alternative procedure, a powder of the polymer is obtained without carrying out in-process neutralization, and then an alkaline compound is added in preparation of the electrode mixture layer-forming composition, to thereby neutralize the polymer (hereinafter may also be referred to as a “post-neutralization”). In the case in which the polymer (A) is produced through precipitation polymerization, in-process neutralization is preferred among the above neutralization techniques, from the viewpoint of ease of disintegration of the secondary aggregate.

In the case in which the polymer (A) is produced through dispersion polymerization, a dispersion in which polymer particles are dispersed in liquid is formed. No particular limitation is imposed on the method of isolating the polymer particles from the dispersion, and any known techniques may be employed. The target polymer particles can be recovered by subjecting the dispersion to a treatment, for example, removal of volatile components (e.g., liquid medium) through distillation, re-precipitation, vacuum drying, heat drying, filtration, centrifugation, or decantation.

### <<Electrode Mixture Layer-Forming Composition>>

The electrode mixture layer-forming composition of the present disclosure is a polymer composition for use in formation of an electrode of a lithium ion secondary battery containing a polymer solid electrolyte (more specifically, an electrode mixture layer). The composition is preferably used as an electrode material for producing a positive electrode (working electrode). The electrode mixture layer-forming composition of the present disclosure (hereinafter may also be abbreviated as “the present composition”) contains the aforementioned polymer (A) and an active material.

The active material incorporated into the present composition is preferably a positive electrode active material. Examples of the positive electrode active material include a compound phosphate salt containing lithium, a compound silicate salt containing lithium, and a lithium salt of a transition metal oxide.

Examples of the compound phosphate salt containing lithium include an olivine-type compound phosphate salt containing lithium. Specific examples of the olivine-type compound phosphate salt containing lithium include a salt represented by “LiMPO₄” (wherein M is one or more members of Fe(II), Mn(II), Co(II), and Ni(II)). Specific examples of the salt represented by “LiMPO₄” include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (wherein a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (wherein c+d+e≤1, 0<c<1, 0<d<1, and 0<e<1), and LiFe_{f}Ni_{g}CoₕMnᵢPO₄ (wherein f+g+h+i≤1, 0<f<1, 0<g<1, 0<h<1, and 0<i<1).

Specific examples of the compound silicate salt containing lithium include Li₂FeSiO₄, Li₂MnSiO₄, and Li₂CoSiO₄.

Examples of the transition metal oxide lithium salt include a layered rock salt-type lithium-containing metal oxide and a spinel-type lithium-containing metal oxide. Specific examples of the layered rock salt-type lithium-containing metal oxide include lithium cobaltate, lithium nickelate, and ternary salts; NCM (i.e., Li(Niₓ,Co_{y},Mn_{z}), x+y+z=1) and NCA (i.e., Li(Ni_{1-a-b}COₐAl_{b})). Specific examples of the spinel-type lithium-containing metal oxide include lithium manganate.

Among them, a compound phosphate salt containing lithium is preferred, with LiFePO₄ (iron lithium phosphate) being particularly preferred. The aforementioned positive electrode active materials may be used singly or in combination of two or more species (i.e., a mixture or a compound).

The polymer (A) is preferably used as a positive electrode binder which binder can bind a positive electrode active material. The polymer (A) content of the present composition is, for example, 0.1 to 20 parts by mass, with respect to the entire amount (100 parts by mass) of the active material contained in the present composition. When the polymer (A) content is 0.1 parts by mass or more, sufficient binding performance and dispersion stability of the active material can be secured. Also, by controlling the polymer (A) content to 20 parts by mass or less, an increase in viscosity of the present composition can be suppressed, whereby coatability of the present composition onto a current collector can be enhanced, which is preferred. From the above viewpoints, the polymer (A) content with respect to the entire amount of the active material is preferably 0.5 parts by mass or more, more preferably 2 parts by mass or more, still more preferably 5 parts by mass or more. Regarding the upper limit, the polymer (A) content with respect to the entire amount (100 parts by mass) of the active material is preferably 19 parts by mass or less, more preferably 17 parts by mass or less, still more preferably 15 parts by mass or less.

The present composition may further contain a component other than the polymer (A) and the active material (hereinafter may also be referred to as an “additional component”). Examples of the additional component include a conducting aid and a medium.

The conducting aid is used for the purpose of enhancing the electrical conductivity of an electrode and for other reasons. Examples of the conducting aid include carbonaceous materials such as carbon black, carbon nanotube, carbon fiber, graphite micropowder, and carbon fiber. Among them, from the viewpoint of provision of high electrical conductivity, carbon black, carbon nanotube, and carbon fiber are preferred. As carbon black, ketjen black or acetylene black is preferred. The conducting aids may be used singly or in combination of two or more species.

From the viewpoint of achieving satisfactory electrical conductivity with energy density, the relative amount of the conducting aid in the present composition, with respect to the entire amount (100 parts by mass) of the active material contained in the present composition, may be adjusted to, for example, 0.2 to 20 parts by mass. The conducting aid content is preferably 0.5 to 17 parts by mass, more preferably 1 to 15 parts by mass.

In order to improve the coatability of the present composition onto a current collector, the composition is preferably a slurry containing the polymer (A) and the active material. In the case of a slurry-form present composition, water is preferably used as a medium. For modifying the property, drying performance, etc. of the present composition, a mixture of water and an aqueous organic solvent may be used as the medium. Examples of the aqueous organic solvent include a lower alcohol such as methanol or ethanol; a carbonate such as ethylene carbonate; a ketone such as acetone; and a cyclic ether such as tetrahydrofuran. When such a solvent mixture is used as a medium, the water content of the solvent mixture is, for example, 50 mass % or more, preferably 70 mass % or more.

When the present composition is prepared in the form of slurry, the relative amount of the medium contained in the present composition, with respect to the entire amount of the present composition, is, for example, 25 to 90 mass %, preferably 35 to 70 mass %. Alternatively, the present composition may be in such a wet powder form that the composition can form an electrode mixture layer on the surface of a current collector by pressing. When the present composition is in the form of wet powder, the medium content of the present composition, with respect to the entire amount of the present composition, is for example, 3 to 40 mass %, preferably 10 to 30 mass %.

So long as the effects of the present disclosure are not impaired, the present composition may contain, as an additional component, a component other than the conducting aid and the medium. Examples of the component other than the conducting aid and the medium include an additional binder such as styrene/butadine-based latex, acrylic latex, and poly(vinylidene fluoride)-base latex.

The present composition may be prepared by mixing the polymer (A), the active material, and an optional and additional component. No particular limitation is imposed on the method of mixing the components, and any known mixing method may be employed. In particular, there is preferred a dispersion kneading method, in which the active material, the conducting aid, and the polymer (A), being powder components, are dry-blended, and the blended product is mixed with a dispersion medium such as water. In preparation of a slurry-form composition, a known mixer such as a planetary mixer, a thin film spin system mixer, or a planetary centrifugal mixer may be used as a mixing apparatus. Among these mixing means, a thin film spin system mixer is preferably employed, from the viewpoint of achieving a favorable dispersion state within a short period of time. When the present composition is prepared in the form of slurry, the viscosity of the slurry is, for example, 500 to 100,000 mPa·s as determined by means of a type B viscometer at 25° C. and a rotor speed of 60 rpm, preferably 1,000 to 50,000 mPa·s.

Meanwhile, when the present composition is prepared in the form of wet powder, the composition is preferably kneaded in a uniform state (i.e., involving no variation in concentration) by means of a Henschel mixer, a blender, a planetary mixer, a twin screw kneader, or the like.

### <<Lithium Ion Secondary Battery Electrode>>

The lithium ion secondary battery electrode of the present disclosure (hereinafter may also be referred to “the present electrode”) has a current collector and an electrode mixture layer. Preferably, the electrode is a positive electrode (working electrode) of a lithium ion secondary battery. When the present electrode is a positive electrode, the current collector (i.e., a positive electrode current collector) is made of a foil of a metal such as aluminum or stainless steel. From the viewpoints of corrosion resistance and mechanical characteristics, an aluminum foil is preferably used as the material of the positive electrode current collector.

The electrode mixture layer is disposed on the surface of the current collector in contact with the current collector, and is formed from the electrode mixture layer-forming composition of the present disclosure. In one procedure of forming the electrode mixture layer, the slurry-form present composition is applied onto the surface of the current collector, and the solvent of the composition is removed by drying. No particular limitation is imposed on the method of applying the present composition onto the surface of the current collector, and any known application method may be employed. Examples of such an application method include doctor blading, dipping, roller coating, comma coating, curtain coating, gravure coating, and extrusion. The dry removal treatment may be conducted through any known method such as hot air blowing, reduced pressure treatment, (far) infrared radiation, or microwave radiation.

After drying, the thus-formed electrode mixture layer is generally subjected to a compression treatment such as metal mold pressing or roller pressing. Through the compression treatment, the active material is caused to be closely bonded to the electrode binder, whereby the strength of the electrode mixture layer and close adhesion to the current collector can be enhanced. Through the compression treatment, the thickness of the electrode mixture layer can be regulated to, for example, about 30 to about 80% the initial thickness. The thickness of the electrode mixture layer after compression is generally about 4 to about 200 m.

### <<Lithium Ion Secondary Battery>>

The lithium ion secondary battery of the present disclosure (hereinafter may also be referred to as “the present secondary battery”) is a secondary battery containing a polymer solid electrolyte and includes the aforementioned lithium ion secondary battery electrode of the present disclosure. More specifically, the present secondary battery has a separator, the positive electrode and the negative electrode, and is an all-solid battery having the separator disposed between the positive electrode and the negative electrode, the separator being formed of a polymer solid electrolyte. In the present secondary battery, the positive electrode of the two electrodes is preferably formed from an electrode mixture layer-forming composition containing the polymer (A). In this case, no particular limitation is imposed on the material forming the negative electrode, and the material to be used may be appropriately selected from any materials known to serve as a material of a lithium ion secondary battery electrode. For example, a metal foil such as a copper foil or a lithium foil may be used as a negative electrode current collector.

The polymer solid electrolyte employed in the secondary battery preferably contains an alkylene carbonate group-containing polymer as a polymer component. Use of a polymer solid electrolyte containing an alkylene carbonate group-containing polymer is preferred, since both flexibility and high ion conductivity can be achieved. Also, by combining a polymer solid electrolyte containing an alkylene carbonate group-containing polymer with an electrode mixture layer formed from an electrode mixture layer-forming composition containing the polymer (A), a lithium ion secondary battery exhibiting excellent cycle characteristics can be produced.

No particular limitation is imposed on the alkylene carbonate group-containing polymer, so long as the polymer has an alkylene carbonate group in the main chain. The alkylene carbonate group-containing polymer to be used is preferably a polymer having a structural unit represented by the following formula (1):

—[O—CO—O—R¹]— (1)

(In formula (1), R¹ represents a C2 to C6 linear-chain or branched-chain alkylene group).

Specific examples of the alkylene carbonate group-containing polymer include polyethylene carbonate, polypropylene carbonate, polyisoprene carbonate, polybutylene carbonate, polypentylene carbonate, and polyhexylene carbonate. Of these, polyethylene carbonate is particularly preferred. These alkylene carbonate group-containing polymers may be used singly or in combination of two or more species.

The polymer solid electrolyte contains a lithium salt as an electrolyte salt. Examples of the lithium salt contained in the polymer solid electrolyte include LiBr, LiCl, LiI, LiSCN, LiBF₄, LiAsF₆, LiClO₄, CH₃COOLi, CF₃COOLi, LiCF₃SO₃, LiPF₆, LiC(CF₃SO₂)₃, lithium bis(fluorosulfonyl) imide (Li⁺(FSO₂)₂N⁻), and lithium bis(trifluoromethanesulfonyl) imide (Li⁺(CF₃SO₂)₂N⁻). Alternatively, a salt formed of the anion of the lithium salt with an alkali metal excepting lithium (e.g., potassium or sodium) may also be employed as the electrolyte salt. Among the aforementioned salts, the electrolyte salt contained in the polymer electrolyte is preferably lithium bis(fluorosulfonyl)imide or lithium bis(trifluoromethanesulfonyl)imide.

In addition to the alkylene carbonate group-containing polymer and the electrolyte salt, the polymer solid electrolyte may further contain an additional component in accordance with needs. Examples of the additional component which may be incorporated into the polymer solid electrolyte include a filler and a leveling agent. So long as the performance of the electrolyte is not impaired, the additional component content of the polymer solid electrolyte may be appropriately selected in accordance with the compound used as the additional component.

No particular limitation is imposed on the method of producing the secondary battery, and any known method may be appropriately employed in accordance with the structure of the target battery and the like. One possible procedure is as follows. Specifically, a positive electrode and a negative electrode each having a current collector and an electrode mixture layer are provided. Onto one of the positive electrode and the negative electrode, a composition for forming a separator (e.g., a composition containing an alkylene carbonate group-containing polymer, an electrolyte salt, and a solvent) is applied through a known coating method. The coating is subjected to a drying treatment (e.g., heating or a reduced pressure treatment) so as to remove the solvent, whereby a separator (polymer solid electrolyte) is formed on one electrode. Thereafter, the other electrode is stacked, to thereby manufacture a stacked body having a positive electrode, a separator, and a negative electrode. The thus-yielded stacked body may be used as a film-type or a coin-type lithium ion battery; a wound-type lithium ion battery; or a stacked-type lithium ion battery. Also, no particular limitation is imposed on the form or the like of the present secondary battery, and examples of the battery form include button, cylinder, square, and laminate.

As described hereinabove, the electrode binder of the present disclosure containing the polymer (A) exhibits excellent binding performance to an active material in the electrode mixture layer as well as excellent adhesion to the current collector. In addition, the electrode binder can enhance the surface flatness and the internal resistance of any of the electrodes, and can improve an initial battery capacity and cycle characteristics of a lithium ion secondary battery.

Particularly, a lithium ion secondary battery containing a polymer solid electrolyte which contains an alkylene carbonate group-containing polymer exhibits high ion conductivity even at room temperature. As a result, a lithium ion secondary battery having excellent battery performance and safety can be provided. Also, since a polymer solid electrolyte containing an alkylene carbonate group-containing polymer has high flexibility, a flexible-type secondary battery can be yielded.

Meanwhile, there has not been elucidated a reason for the improvement in the surface flatness of the lithium ion secondary battery electrode obtained by use of the electrode binder containing the polymer (A). However, one conceivable reason is that a polymer network can be readily formed in the electrode mixture layer-forming composition (preferably, an aqueous slurry) by virtue of a long primary chain length of the polymer (A), to thereby enhance dispersibility of the active material in the electrode (s). Another conceivable reason why the lithium ion secondary battery produced by use of the electrode binder containing the polymer (A) exhibits excellent cycle characteristics is that a sufficiently long primary chain length of the polymer (A) employed as the electrode binder, and the presence of a polar functional group promote the interaction with the component(s) of the polymer solid electrolyte, whereby close adhesion between the electrode(s) and the polymer solid electrolyte is enhanced, leading to improvement in durability. Particularly when the polymer solid electrolyte contains an alkylene carbonate group-containing polymer, interaction between the carbonyl group of the alkylene carbonate group-containing polymer and the polar functional group of the polymer (A) is promoted, which is preferred.

The lithium ion secondary battery of the present disclosure finds various uses. Specific examples include a power source for applications, for example, mobile devices such as mobile phones, personal computers, smart phones, game machines, and wearable terminals; mobile bodies such as electric vehicles, hybrid vehicles, robots, and drones; and electronic/electric appliances such as digital cameras, video cameras, music players, electric power tools, and domestic electric products.

### EXAMPLES

The disclosure will be described more specifically by way of example, which should not be construed as limiting the disclosure thereto. Unless otherwise specified, the units “part(s)” and “%” refer to “part(s) by mass” and “mass %,” respectively.

### 1. Production of Carboxyl Group-Containing Polymer (Salt)

### Production Example 1: Production of Cross-Linked Polymer Salt R-1

In polymerization, a reactor equipped with an agitation paddle, a thermometer, a reflux condenser, and a nitrogen-feeding pipe was employed. To the reactor, there were added acetonitrile (567 parts), ion exchange water (2.20 parts), acrylic acid (hereinafter also abbreviated as “AA”) (100.0 parts), trimethylolpropane diallyl ether (“NEOALLYL T-20,” product of OSAKA SODA Co., Ltd.) (0.90 parts), and triethylamine as a basic compound. The amount of triethylamine was adjusted to 1.0 mol % with respect to AA. The atmosphere of the reactor was thoroughly purged with nitrogen, and the reactor was heated to 55° C. After achievement of a stable internal temperature of 55° C., 2,2′-azobis (2,4-dimethylvaleronitrile) (“V-65,” product of FIJIFILM Wako Pure Chemical Corporation) (0.040 parts) serving as a polymerization initiator was added to the reactor. Since the reaction mixture was clouded, that point of time was regarded as the start of polymerization. The monomer concentration was calculated as 15.0%. By controlling the external temperature (i.e., the temperature of a water bath), the internal temperature was maintained at 55° C., and the polymerization reaction was continued. Twelve hours after the start of polymerization, the reaction mixture was cooled. When the internal temperature was lowered to 25° C., a powder of lithium hydroxide monohydrate (hereinafter referred to as “LiOH·H₂O”) (52.4 parts) was added thereto. After addition of the lithium salt, the mixture was continuously agitated for 12 hours at room temperature, to thereby yield a slurry-form polymerization reaction mixture in which particles of a salt of a cross-linked polymer having a carboxyl group (Li salt, neutralization degree of 90 mol %) were dispersed in a medium. The salt of a cross-linked polymer having a carboxyl group obtained through the above reaction is referred to as “cross-linked polymer salt R-1.”

The thus-obtained polymerization reaction mixture was subjected to centrifugation, to thereby precipitate polymer particles, and then the supernatant was removed. Subsequently, the sediment was re-dispersed in acetonitrile in the same amount (by mass) as that of the polymerization reaction mixture. A washing operation including precipitating polymer particles through centrifugation and removing the supernatant was repeated twice. Thus, the sediment was recovered and dried at 80° C. for 3 hours under reduced pressure, to thereby remove the volatile matter, whereby a powder of cross-linked polymer salt R-1 was yielded. Since cross-linked polymer salt R-1 had hygroscopicity, the polymer salt was stored and sealed in a container having water vapor barrier property. An IR spectrum of the powder of cross-linked polymer salt R-1 was measured. The neutralization degree was determined on the basis of the ratio in intensity of a peak attributed to C═O group (Li carbonate) to a peak attributed to C═O group (carboxylic acid). As a result, the neutralization degree was found to be 90 mol %, which was the same as the corresponding value calculated from the preparation amounts of materials.

### Production Examples 2 to 5: Production of Cross-Linked Polymer Salts R-2 to R-5

The procedure of Production Example 1 was repeated, except that the amounts of the raw materials were changed to the values shown in Table 1, to thereby yield polymerization reaction mixtures each containing each of cross-linked polymer salts R-2 to R-5. Each polymerization reaction mixture was subjected to the same procedure as conducted in Production Example 1, to thereby yield a powder of each of cross-linked polymer salts R-2 to R-5. Since cross-linked polymer salt had hygroscopicity, the polymer salt was stored and sealed in a container having water vapor barrier property. Similar to Production Example 1, the neutralization degree of each cross-linked polymer salt was determined. As a result, the neutralization degrees were found to be the same as the corresponding values calculated from the preparation amounts of materials. Table 2 shows the neutralization degree values of cross-linked polymer salts R-2 to R-5.

TABLE 1

| | | | Production | Production | Production | Production | Production |
|---|---|---|---|---|---|---|---|
| Production Example No. | | | Example 1 | Example 2 | Example 3 | Example 4 | Example 5 |
| Cross-linked polymer (salt) | | | R-1 | R-2 | R-3 | R-4 | R-5 |
| Preparation | Non-cross- | AA [parts] | 100.0 | 100.0 | 60.0 | 100.0 | 100.0 |
| of | linkable monomer | HEA [parts] | | | 40.0 | | |
| materials | Cross-linkable | T-20 [parts] | 0.9 | | 0.9 | 0.3 | 3.0 |
| | monomer | P-30 [parts] | | 0.6 | | | |
| | | Amount of use | 0.30% | 0.17% | 0.36% | 0.10% | 1.00% |
| | | [mol %] *1 | | | | | |
| | Basic compound | TEA [mol %] *2 | 1.0 | 1.0 | 1.0 | 1.0 | 1.0 |
| | Polymerization | Ion exchange | 2.20 | 2.20 | 2.20 | 2.20 | 2.20 |
| | solvent | water [parts] | | | | | |
| | | AcN [parts] | 567 | 567 | 567 | 567 | 567 |
| | Polymerization | V-65 [parts] | 0.040 | 0.040 | 0.040 | 0.040 | 0.040 |
| | initiator | | | | | | |
| | In-process | LiOH•H₂O | 52.4 | 43.7 | 31.4 | 52.4 | 52.4 |
| | neutralization | [parts] | | | | | |

| | | | | | |
|---|---|---|---|---|---|
| Initial monomer concentration | 15% | 15% | 15% | 15% | 15% |

*1 Amount (mol %) to entire amount of non-cross-linkable monomer (s)
*2 Amount of Basic compound represents amount (mol %) to amount of acrylic acid (AA)

Details of the compounds shown in Table 1 are as follows.
AA: acrylic acid
HEA: 2-hydroxyethyl acrylate
T-20: trimethylolpropane diallyl ether (“NEOALLYL T-20,” product of OSAKA SODA Co., Ltd.)
P-30: pentaerythritol triallyl ether (“NEOALLYL P-30,” product of OSAKA SODA Co., Ltd.)
TEA: triethylamine
AcN: acetonitrile
V-65: 2,2′-azobis(2,4-dimethylvaleronitrile) (product of FIJIFILM Wako Pure Chemical Corporation)
LiOH·H₂O: lithium hydroxide monohydrate

### 2. Preparation and Viscosity Measurement of 5 Mass % Aqueous Solution of Carboxyl Group-Containing Polymer (Salt)

### (1) Cross-Linked Polymer Salts (R-1 to R-5)

Each of cross-linked polymer salts (R-1 to R-5) (5 parts) and ion exchange water (95 parts) were weighed and placed in a container, and the container was set in a planetary centrifugal mixer (Awatori Rentaro AR-250, product of Thinky Corporation). Subsequently, agitation (rotation speed: 2,000 rpm/revolution speed: 800 rpm, 7 minutes) and defoaming (rotation speed: 2,200 rpm/revolution speed: 60 rpm, 1 minute) were alternatingly conducted in a repeating manner until no un-swollen powder portion was confirmed. Thus, a hydrogel dispersion in which the gel swelled in water was obtained. The temperature of each of the thus-obtained hydrogel dispersions was adjusted to 25° C.±1° C. The viscosity of 5 mass % aqueous solution of each hydrogel dispersion was measured by means of a type-B viscometer (TVB-10, product of Toki Sangyo Co., Ltd.) at a rotor speed of 12 rpm. The measurement results are shown in Table 2.

Meanwhile, the viscosity of 5 mass % aqueous solution of cross-linked polymer salt R-1 was measured by means of a type-E viscometer (TV-20, product of Toki Sangyo Co., Ltd.) at a rotor speed of 0.6 rpm and was 631,000 mPa·s.

### (2) Poly(Acrylic Acid) Powder (AC-10SHP)

Poly(acrylic acid) powder (“JURYMER AC-10SHP,” product of TOAGOSEI Co., Ltd., hereinafter may also be referred to simply as “AC-10SHP”) was dissolved in ion exchange water, to thereby prepare a 5 mass % aqueous solution of poly(acrylic acid). By adding lithium hydroxide monohydrate (LiOH·H₂O) to the solution for neutralization of poly(acrylic acid), an aqueous solution in which a polymer salt having a neutralization degree of 90 mol % was dissolved in water was obtained. The temperature of the thus-obtained solution was adjusted to 25° C.±1° C. The viscosity of 5 mass % aqueous solution was measured by means of a type-B viscometer (TVB-10, product of Toki Sangyo Co., Ltd.) at a rotor speed of 12 rpm. Table 2 shows the results.

### (3) Poly(Acrylic Acid) Powder (PAA)

Poly(acrylic acid) powder (“poly(acrylic acid) 250,000,” product of FIJIFILM Wako Pure Chemical Corporation, hereinafter may also be referred to simply as “PAA”) was dissolved in ion exchange water, to thereby prepare a 5 mass % aqueous solution of poly (acrylic acid). By adding lithium hydroxide monohydrate (LiOH·H₂O) to the solution for neutralization of poly(acrylic acid), an aqueous solution in which a polymer salt having a neutralization degree of 90 mol % was dissolved in water was obtained. The temperature of the thus-obtained solution was adjusted to 25° C.±1° C. The viscosity of 5 mass % aqueous solution was measured by means of a type-B viscometer (TVB-10, product of Toki Sangyo Co., Ltd.) at a rotor speed of 12 rpm. Table 2 shows the results.

### 3. Manufacture and Evaluation of Lithium Ion Secondary Battery [Example 1]

### (1) Manufacture of Electrode Plate for Working Electrode (i.e., Positive Electrode Plate)

Iron lithium phosphate (“Lithium iron phosphate,” product of Tatung Fine Chemicals) serving as an active material (80 parts), acetylene black (“DENKA BLACK,” product of Denka Co., Ltd.) serving as a conducting aid (10 parts), cross-linked polymer salt R-1 serving as an electrode binder (10 parts), and water serving as a medium (400 parts by mass) were mixed together by means of Awatori Rentaro (2,000 rpm, 20 minutes), to thereby prepare an electrode mixture layer-forming composition. The electrode mixture layer-forming composition was applied to a current collector made of aluminum (thickness: 20 μm) and dried, to thereby form a working electrode mixture layer serving as an electrode mixture layer. The product was rolled to adjust the thickness and mixture density of the working electrode mixture layer to 55 μm and 0.7 g/cm³, respectively. The sheet was punched to provide a disk (diameter: 1.4 cm) for serving as an electrode plate for a working electrode (hereinafter may be referred to simply as a “working electrode plate”).

### (2) Manufacture of Negative Electrode Plate

A metallic lithium foil having a thickness of 20 μm (product of Honjo Metal Co., Ltd.) was punched to provide a disk (diameter: 1.5 cm) for serving as a negative electrode plate.

### (3) Manufacture of Stacked Body Including Working Electrode Plate and Solid Electrolyte

Polyethylene carbonate (PEC (weight average molecular weight: 250,000), product of Empower Materials) (100 parts) and lithium bis(fluorosulfonyl)imide (LiFSI, product of Kishida Chemical Co., Ltd.) (213 parts) were dissolved in acetonitrile. The thus-prepared solution was applied onto the electrode plate of the working electrode produced in (1) above, and dried, to thereby dispose a solid electrolyte layer having a thickness of 2 μm on the working electrode plate. Thus, a stacked body of the working electrode plate and the solid electrolyte was formed.

### (4) Manufacture of Coin-Type Battery

On the solid electrolyte included in the stacked body of the working electrode plate and the solid electrolyte manufactured in (3) above, the negative electrode manufactured in (2) above was laminated. The laminated product was placed in a battery container, to thereby manufacture a coin-type lithium ion secondary battery.

The coin-type battery manufactured in (4) above was evaluated in terms of the following battery characteristics (i.e., resistance of electrode, cycle characteristics, and surface flatness of electrode).

### Resistance of Electrode (Resistance of Working Electrode)

The coin-type battery obtained above was subjected to AC impedance measurement (application voltage: 30 mV, frequency 1 MHz to 0.1 Hz) by means of a potentiostat/galvanostat (SP-300, product of BioLogic), whereby a Nyquist plot was obtained. Meanwhile, AC impedance measurement is a technique of measuring a resistance component by applying AC. The thus-obtained Nyquist plot was subjected to a fitting calculation by use of an equivalent circuit. As a result, the resistance of the working electrode was found to be 324Ω.

### Cycle Characteristics

The coin-type battery obtained above was subjected to charge/discharge measurement by means of a charge/discharge apparatus (HJ1001SM8A system, product of Meiden Hokuto Corporation) in the following manner. Firstly, a charge/discharge operation was conducted through CC discharge at 2.2 V to 4.5 V and a charge/discharge rate of 0.1 C, whereby an initial capacity C₀ was determined. The determined value of the initial capacity was 155 mAh/g. Further, a charge/discharge operation was repeated at 60° C., and the capacity after 20 cycles (C₂₀) was determined. As a result, the capacity maintenance ΔC₂₀ was 99%. The higher the capacity maintenance ΔC₂₀, the more suitable the cycle characteristics.

ΔC₂₀=C₂₀/C₀×100(%)

### Surface Flatness of Electrode

The surface of each working electrode was observed under a scanning electron microscope (SEM, apparatus: JCM600 Plus, product of JEOL Ltd.), and the surface was assessed on the basis of the following ratings. The working electrode of Example 1 was evaluated as “0”.

### (Ratings of Evaluation)

◯: No anomalous appearance (roughness) observed on the surface
Δ: Slight (small number of) roughness observed on the surface
X: Considerably anomalous appearance (considerable roughness, cracking, etc.) observed on the surface

### Examples 2 to 6 and Comparative Example 1

The procedure of Production Example 1 was repeated, except that the amounts of the raw materials were changed to the values shown in Table 2, to thereby manufacture button-type batteries. Each of the manufactured button-type batteries was subjected to the same battery evaluation as performed in Example 1. Table 2 shows the results.

### Comparative Example 2

The procedure of Production Example 1 was repeated, except that the amounts of the raw materials were changed to the values shown in Table 2, to thereby manufacture a button-type battery. The medium used in the electrode mixture layer-forming composition was changed from water to N-methyl-2-pyrrolidone (NMP) capable of dissolving the electrode binder. The manufactured button-type batteries were subjected to the same battery evaluation as performed in Example 1. Table 2 shows the results.

TABLE 2

| Examples. Comparative | | | Example | Example | Example | Example | Example | Example | Comparative | Comparative |
|---|---|---|---|---|---|---|---|---|---|---|
| Examples (No.) | | | 1 | 2 | 3 | 4 | 5 | 6 | Example 1 | Example 2 |
| Electrode | Electrode | Type | R-1 | R-2 | R-3 | R-4 | R-5 | AC-10SHP | PAA | PVDF |
| mixture | binder | (parts) | 10 | 10 | 10 | 10 | 10 | 10 | 10 | 10 |
| layer- | Neutralizer | LiOH•H₂O | 0 | 0 | 0 | 0 | 0 | 5.2 | 5.2 | 0 |
| forming | Active | LFP | 80 | 80 | 80 | 80 | 80 | 80 | 80 | 80 |
| composition | material | | | | | | | | | |
| [parts] | Conducting | AB | 10 | 10 | 10 | 10 | 10 | 10 | 10 | 10 |
| | aid | | | | | | | | | |
| | Medium | Water | 400 | 400 | 400 | 400 | 400 | 400 | 400 | |
| | | NMP | | | | | | | | 400 |
| Neutralization degree of | | | 90% | 75% | 90% | 90% | 90% | 90% | 90% | — |
| cross-linked polymer salt | | | | | | | | | | |
| [mol%] | | | | | | | | | | |
| Aqueous solution | | 5 | >50,000 | >50,000 | 32,110 | >50,000 | 25,320 | 17,920 | 1,960 | — |
| viscosity [mPa · s] | | mass% | | | | | | | | |
| Evaluation | Electrode | Rating | ◯ | ◯ | ◯ | ◯ | ◯ | ◯ | X | Δ |
| results | surface | | | | | | | | | |
| | flatness | | | | | | | | | |
| | Electrode | [Ω] | 324 | 383 | 336 | 314 | 361 | 367 | 492 | 447 |
| | resistance | | | | | | | | | |
| | Initial | C₀ | 155 | 150 | 155 | 154 | 154 | 152 | 80 | 119 |
| | capacity | [mAh/g] | | | | | | | | |
| | Cycle | ΔC₂₀ | 99 | 92 | 99 | 98 | 95 | 94 | charge/ | 82 |
| | characteristic | [%] | | | | | | | discharge | |
| | | | | | | | | | failure | |

Details of the compounds shown in Table 2 are as follows.
AC-10SHP: poly(acrylic acid) powder (“JURYMER AC-10SHP,” product of TOAGOSFI Co., Ltd.)
PAA: poly(acrylic acid) powder (“poly(acrylic acid) 250,000,” product of FIJIFILM Wako Pure Chemical Corporation)
PVDF: poly(vinylidene fluoride) (“Solef5130,” product of Solvay)
LFP: iron lithium phosphate (“Lithium iron phosphate,” product of Tatung Fine Chemicals)
AB: acetylene black (“DENKA BLACK,” product of Denka Co., Ltd.)
NMP: N-methyl-2-pyrrolidone

### 4. Results of Evaluation

As is clear from Table 2, the lithium ion secondary batteries of Examples 1 to 6, each containing a polymer solid electrolyte employing a carboxyl group-containing polymer salt whose 5 mass % aqueous solution exhibits a viscosity of 10,000 mPa·s or more at 25° C. as an electrode binder, were found to exhibit excellent surface flatness of the electrode, small internal resistance of the electrode, and high initial battery capacity (i.e., excellent cycle characteristics), as compared with the lithium ion secondary battery of Comparative Example 1, containing a polymer solid electrolyte employing a carboxyl group-containing polymer salt whose 5 mass % aqueous solution exhibits a viscosity of 1,960 mPa·s at 25° C. as an aqueous binder, and with the lithium ion secondary battery of Comparative Example 2, employing an organic solvent-based binder PVDF.

In Comparative Example 1, dispersibility of the active material in the electrode was low, and considerably anomalous appearance (e.g., roughness) was observed on the surface of the electrode. In addition, since a considerable drop in battery capacity was observed in a few initial cycles of the cycle characteristic test, evaluation of cycle characteristics was suspended before reaching 20 cycles.

Among the batteries of Examples 1 to 6, those of Examples 1, 3, and 4, each employing a less cross-linkable electrode binder which had sufficiently high lithium neutralization degree and which employed a smaller amount of the cross-linkable monomer, were found to exhibit excellent cycle characteristics. A conceivable reason for this is that the less cross-linkable electrode binder can readily form a wide polymer network in water.

The above-described test results have proven the following. That is, an electrode which exhibits excellent surface flatness and small internal resistance can be produced by manufacturing a lithium ion secondary battery by use of the electrode binder of the present disclosure. Also, a lithium ion secondary battery which exhibits high initial battery capacity and excellent cycle characteristics can be produced.

The present invention is not limited to the aforementioned embodiments. Needless to say, the present invention encompasses various modifications and those falling within the equivalents thereof, so long as they are not deviated from the gist of the present invention. Thus, it should be construed that, in view of the above teaching, those skilled in the art could conceive various combinations, modes, and further embodiments of a single element or a combination including the element or its equivalent, which also fall within the scope or concept of the present invention.

1. An electrode binder of a lithium ion secondary battery comprising a polymer solid electrolyte, wherein
the electrode binder comprises a polymer (A) which is a carboxyl group-containing polymer or a salt thereof, and a 5 mass % aqueous solution of the polymer (A) has a viscosity of 10,000 mPa·s or more at 25° C.

2. The electrode binder according to claim 1, wherein the polymer (A) has a neutralization degree of 70 mol % or higher.

3. The electrode binder according to claim 1, wherein
the polymer (A) comprises a structural unit derived from a cross-linkable monomer, and a relative amount of the structural unit derived from the cross-linkable monomer in the polymer (A) with respect to an entire amount of a structural unit derived from a monomer other than the cross-linkable monomer is 0.001 mol % to 2.5 mol %.

4. The electrode binder according to claim 1, wherein
the polymer (A) comprises a structural unit derived from an ethylenically unsaturated monomer having a carboxyl group, and
a relative amount of the structural unit derived from the ethylenically unsaturated monomer having a carboxyl group in the polymer (A) with respect to all the structural units of the polymer (A) is 50 mass % or more.

5. The electrode binder according to claim 1, wherein the polymer solid electrolyte comprises an alkylene carbonate group-containing polymer.

6. The electrode binder according to claim 5, wherein the alkylene carbonate group-containing polymer is polyethylene carbonate.

7. The electrode binder according to claim 1, wherein the polymer (A) is a lithium salt of the carboxyl group-containing polymer.

8. The electrode binder according to claim 1, which is a positive electrode binder.

9. An electrode mixture layer-forming composition of a lithium ion secondary battery comprising a polymer solid electrolyte, wherein
the composition comprises the electrode binder according to claim 1 and an active material.

10. The electrode mixture layer-forming composition according to claim 9, wherein the active material is iron lithium phosphate.

11. The electrode mixture layer-forming composition according to claim 9, further comprising a conducting aid.

12. A lithium ion secondary battery electrode, the electrode comprising a current collector, and an electrode mixture layer disposed on a surface of the current collector, wherein
the electrode mixture layer is formed from the electrode mixture layer-forming composition according to claim 9.

13. A lithium ion secondary battery comprising the lithium ion secondary battery electrode according to claim 12.
